(19) United States
(12) Patent Application Publication
(10) Pub. No.: US 2010/0252226 A1
(43) Pub. Date: Oct. 7, 2010

(54) ALKALINE PHENOLIC RESOLE RESIN COMPOSITIONS AND THEIR USE

(76) Inventors: Carlito G. Bangcuyo, Dublin, OH (US); Timothy A. Ropp, Columbus, OH (US); Jorg Kroker, Powell, OH (US)

Correspondence Address: ASHLAND LICENSING AND INTELLECTUAL PROPERTY, LLC, 5200 BLAZER PARKWAY, DUBLIN, OH, 43017, US

(21) Appl. No.: 12/723,982

(22) Filed: Mar. 15, 2010

Related U.S. Application Data
(60) Provisional application No. 61/167,357, filed on Apr. 7, 2009.

(51) Int. Cl. B22C 9/00; B22C 1/22; C11D 3/20

(52) U.S. Cl. 164/526; 523/145; 510/241

(57) ABSTRACT

An alkaline phenolic resole resin compositions comprising (a) an aqueous basic solution of a phenolic resole resin, (b) and a polyhydric alcohol, and their use in foundry applications.

### RELATED APPLICATIONS

This application claims priority to U.S. Provisional Patent Application Ser. No. 61/167,357, filed Apr. 7, 2009.

### BACKGROUND

It is known to use aqueous basic solutions of phenolic resins to make foundry shapes. Cured foundry shapes comprising aqueous basic solutions of phenolic resins can be made by the no-bake or cold-box process using liquid esters or vapors of volatile esters as the co-reactant, or using carbon dioxide. See for instance U.S. Pat. Nos. 4,468,359, 4,474,904, and 4,977,209.

It is also known that aqueous basic solutions of phenolic resins are not stable over time, particularly if the resin is exposed to warmer temperatures. Evidence of the instability of the resin is reflected in a viscosity increase in the resin, which indicates that the molecular weight of the resin is increasing.

It is also known that aqueous basic solutions of phenolic resins are prone to skin formation, i.e. the formation of a crust on the surface of the resin in the storage container. If a crust forms on the surface of the resin solution, this crust breaks down mechanically when the resin is used and forms flakes which sink to the bottom of the storage container. Because from a practical perspective it is difficult to dissolve these flakes by agitation, the flakes clog filter screens when the resin solution is pumped to a mixer where it is mixed with an aggregate such as sand and, in case of a no-bake process, also a co-reactant, to form the mixture which is then used to produce the foundry shapes.

It is also known to use surfactants to solve the problems previously identified. The problem with using surfactants is that they do not work satisfactorily or they cause other problems such as phase separation when the resin is exposed to low temperatures.

### SUMMARY

The disclosure describes alkaline phenolic resole resin compositions comprising (a) an aqueous basic solution of a phenolic resole resin, (b) and a polyhydric alcohol. The resin compositions are particularly useful as foundry binders. The disclosure also describes foundry mixes made with the binder, a process for preparing foundry shapes, foundry shapes prepared by the process, a process for casting a metal part using the foundry shapes, and a metal part prepared by the process.

The alkaline phenolic resole resin compositions are storage stable and not prone to skin formation because the alkaline phenolic resole resin compositions do not crust and flakes do not form. Consequently, agitation of the alkaline phenolic resole resin composition is not required and filters are not clogged when the alkaline phenolic resole resin composition is pumped to the mixer where the alkaline phenolic resole resin composition is combined with an aggregate from which foundry cores and molds are made.

Although not necessarily preferred the preferred way of solving the problems known in the prior art, which were previously discussed, the disclosure also describes a process for dissolving the crusted surface of an aqueous alkaline solution of the phenolic resole resin or the flakes formed when the crusted surface is subjected to mechanical forces. The process involves treating the aqueous alkaline solution of the phenolic resole resin with a polyhydric alcohol.

### DISCLOSURE

The aqueous alkaline solutions of phenolic resole resins used in the alkaline phenolic resole resin compositions are well known in the art. See for instance U.S. Pat. Nos. 4,468,359, 4,474,904, and 4,977,209, which are hereby incorporated by reference into this disclosure. The other required component of the alkaline phenolic resole resin compositions is a polyhydric alcohol, preferably a monomeric polyhydric alcohol having an OH functionality of 2.5 to 5.0 per mole. Preferably, the polyhydric alcohol is selected from the group consisting of sugar alcohols like glycerol, erythritol, arabitol and alcohols like trimethylol ethane, trimethylol propane, pentaerythritol and polyvinylalcohol, and mixtures thereof. Most preferably, the polyhydric alcohol is glycerol. The amount of polyhydric alcohol used in the alkaline phenolic resole resin composition is an effective stabilizing amount, which is typically from 0.5 to 15 weight percent based upon the weight to the alkaline phenolic resole resin, preferably from 0.8 to 10 weight percent, and most preferably from 0.9 to 5 weight percent.

The specific method for preparing the aqueous solutions of phenolic resole resins used in the alkaline phenolic resole resin compositions is not believed to be critical. Those skilled in this art will know what conditions to select depending upon the specific application.

The general procedure for preparing the aqueous alkaline solutions of phenolic resole resin involves reacting an excess of an aldehyde with a phenolic compound in the presence of a basic catalyst at temperatures of about 40° C. to about 120° C., typically from about 50° C. to about 90° C. Generally the reaction is carried out in the presence of water. Preferably, the resulting phenolic resole resin is diluted with a base and/or water so that an aqueous basic solution of the phenolic resole resin results having the following characteristics (1) a viscosity of less than about 850 centipoises, preferably less than about 450 centipoises at 25° C. as measured with a Brookfield viscometer, spindle number 3 at number 12 setting; (2) a solids content of 35 percent by weight to 75 percent by weight, preferably 50 percent by weight to 60 percent by weight, based upon the total weight of the aqueous basic solution, as measured by a weight loss method by diluting 0.5 gram of aqueous resole solution with one milliliter of methanol and then heating on a hotplate at 150° C. for 15 minutes; and (3) an equivalent ratio of base to phenol of from 0.2:1.0 to 1.1:1.0, preferably from 0.3:1.0 to 0.95:1.0.

The phenols used to prepare the phenolic resole resins include any one or more of the phenols which have heretofore been employed in the formation of phenolic resins and which are not substituted at either the two ortho-positions or at one ortho-position and the para-position. Such unsubstituted positions are necessary for the polymerization reaction. Any one, all, or none of the remaining carbon atoms of the phenol ring can be substituted. The nature of the substituent can vary widely and it is only necessary that the substituent not interfere in the polymerization of the aldehyde with the phenol at the ortho-position and/or para-position. Substituted phenols employed in the formation of the phenolic resins include alkyl-substituted phenols, aryl-substituted phenols, cyclo-alkyl-substituted phenols, aryloxy-substituted phenols, and halogen-substituted phenols, the foregoing substituents containing from 1 to 26 carbon atoms and preferably from 1 to 12 carbon atoms.

Specific examples of suitable phenols include phenol, 2,6-xylenol, o-cresol, p-cresol, 3,5-xylenol, 3,4-xylenol, 2,3,4-trimethyl phenol, 3-ethyl phenol, 3,5-diethyl phenol, p-butyl phenol, 3,5-dibutyl phenol, p-amyl phenol, p-cyclohexyl phenol, p-octyl phenol, 3,5-dicyclohexyl phenol, p-phenyl phenol, p-crotyl phenol, 3,5-dimethoxy phenol, 3,4,5-trimethoxy phenol, p-ethoxy phenol, p-butoxy phenol, 3-methyl-4-methoxy phenol, and p-phenoxy phenol. Multiple ring phenols such as bisphenol A are also suitable.

The aldehyde used to react with the phenol has the formula RCHO wherein R is a hydrogen or hydrocarbon radical of 1 to 8 carbon atoms. The aldehydes reacted with the phenol can include any of the aldehydes heretofore employed in the formation of phenolic resins such as formaldehyde, acetaldehyde, propionaldehyde, furfuraldehyde, and benzaldehyde. In general, the aldehydes employed have the formula RCHO wherein R is hydrogen or a hydrocarbon radical of 1 to 8 carbon atoms. The most preferred aldehyde is formaldehyde.

The basic catalysts used in preparing the phenolic resole resin include basic catalysts such as alkali or alkaline earth hydroxides, and organic amines. The amount of catalyst used will vary depending upon the specific purposes. Those skilled in the art are familiar with the levels needed.

It is possible to add compounds such as lignin and urea when preparing the phenol formaldehyde resole resins as long as the amount is such that it will not detract from achieving the desired properties of the aqueous basic solutions. Urea is added as a scavenger to react with unreacted formaldehyde and decrease the odor caused by it. Although urea may be added for these purposes, it is believed that lower long term tensile strengths may result by the addition of urea. Therefore, if long term tensile strengths are of paramount importance, the urea should be avoided.

The phenolic resole resins used in the practice of this invention are generally made from phenol and formaldehyde at a mole ratio of formaldehyde to phenol in the range of from about 1.1:1.0 to about 3.0:1.0. The most preferred mole ratio of formaldehyde to phenol is a mole ratio in the range of from about 1.4:1.0 to about 2.2:1.0.

The phenolic resole resin is either formed in the aqueous basic solution, or it is diluted with an aqueous basic solution. The base used in the aqueous basic solution is usually a dilute solution of an alkali or alkaline earth metal hydroxide, such as potassium hydroxide, sodium hydroxide, calcium hydroxide, or barium hydroxide, preferably potassium hydroxide or mixtures of sodium hydroxide and potassium hydroxide, in water such that the solution typically contains from about 50 to about 55 percent water by weight.

Foundry mixes are prepared by mixing the binder with a foundry aggregate. Generally the aggregate will be sand which contains at least 70 percent by weight silica. Other suitable sand includes zircon, olivine, alumina-silicate sand, chromite sand, and the like, but also man-made aggregate such as CERABEADS®. Generally, the particle size of the aggregate is such that at least 80 percent by weight of the aggregate has an average particle size between 50 and 150 mesh (Tyler Screen Mesh). The aggregate typically constitutes the major (typically more than 80 percent by weight of the total weight of the foundry mix and the binder constitutes a relatively minor amount). The amount of binder is generally no greater than about ten percent by weight and frequently within the range of about 0.5 to about 7 percent by weight based upon the weight of the aggregate. Most often, the binder content ranges from 0.6 to about 5.0 percent by weight based upon the weight of the aggregate in most foundry shapes.

Foundry shapes, e.g. molds and cores, are made by the no bake or cold box process by methods well known in the art. In the no bake process, the foundry mix is mixed with a liquid ester co-reactant, inserted into a pattern where it is shaped, and allowed to cure until the shape can be handled. Examples of liquid ester co-reactants include lactones, organic carbonates, carboxylic acid esters, and mixtures thereof. Generally, low molecular weight lactones are suitable, such as gamma-butyrolactone, valerolactone, caprolactone, beta-propiolactone, beta-butyrolactone, isopentylactone and delta-pentylactone. Carboxylic acid esters which are suitable include those of short and medium chain length, i.e., about C₁ to C₁₀ carboxylic acids. Specific carboxylic acid esters include, but are not limited to, n-butyl acetate, ethylene glycol diacetate, triacetin (glycerol triacetate), dimethyl glutarate, and dimethyl adipate. Suitable organic carbonates include ethylene carbonate, propylene carbonate, 1,2-butanediol carbonate, 1,3-butanediol carbonate, 1,2-pentanediol carbonate and 1,3-pentanediol carbonate.

Foundry shapes made by the cold box process entail blowing the foundry mix into a pattern which gives it a shape, contacting the shaped foundry mix with the vapor of a volatile co-reactant such as a volatile ester or carbon dioxide according to methods well know in the art. Examples of volatile esters include alkyl formats having from 1 to 3 carbon atoms in the alkyl group, preferably methyl formate.

The amount of co-reactant used is in the range 20% to 110%, preferably 25% to 40% by weight on the weight of resin solution used, corresponding approximately to 10% to 80% by weight on the weight of solid resin in the solution. The optimum in any particular case will depend on the ester chosen and the properties of the resin.

A variety of optional constituents can be used in the binder system. A particularly useful additive to the binder compositions in certain types of sand is a silane such as those having the general formula:

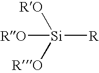

wherein R′ is a hydrocarbon radical and preferably an alkyl radical of 1 to 6 carbon atoms and R is an alkyl radical, an alkoxy-substituted alkyl radical, or an alkyl-amine-substituted alkyl radical in which the alkyl groups have from 1 to 6 carbon atoms. Such silanes, when employed in concentrations of 0.1% to 2%, based on the phenolic binder and hardener, improve the humidity resistance of the system.

Examples of commercially available silanes include Dow Corning Z6040 and Union Carbide A-187 (gamma glycidoxy propyltrimethoxy silane); Union Carbide A-1100 (gamma aminopropyltriethoxy silane); Union Carbide A-1120 (N-beta(aminoethyl)-gamma-amino-propyltrimethoxy silane); and Union Carbide A-1160 (ureido-silane).

Although not necessarily the preferred way of solving the problems known in the prior art, the disclosure also describe a process for dissolving the crusted surface of an aqueous alkaline solution of the phenolic resole resin or the flakes formed when the crusted surface is subjected to mechanical forces. The process involves treating the aqueous alkaline solution of the phenolic resole resin with a polyhydric alcohol.

### Abbreviations

NOVASET HP® resin NOVASET HP® resin is a commercially available aqueous alkaline phenolic resole resin sold by Ashland Inc. The resin is a phenol-formaldehyde base catalyzed resole condensate prepared by reacting phenol, paraformaldehyde, and water in the presence of dilute alkali hydroxide bases at elevated temperatures. The resin has a solids content of about 50-55% percent and a viscosity of about 30-60 centipoise at 25° C. The resin also contains 0.5-1.0% parts by weight (pbw) of a silane, wherein the pbw is based upon the weight or the resin.

NOVASET CO-REACTANT 6020 The co-reactant for the NOVASET HP® resin consists mostly of triacetin and minor amounts of DBE.

### EXAMPLES

### Control A and B and Examples 1-4)

In the examples, NOVASET HP® resin was used as the resin. In Control A and Control B, no glycerol was added to the NOVASET HP® resin. In Examples 1 and 2, one weight percent of glycerol was added to the NOVASET HP® resin, whereas in Examples 3 and 4, ten weight percent of glycerol was added to the NOVASET HP® resin, where the weight percent was based upon the weight percent of the resin. In Control A, Example 1 and Example 3, the samples were aged at room temperature. For Control B, Example 2, and Example 4, the procedure of Control B, and Examples 1 and 3 was repeated, except the samples were aged at 40° C. In order to determine how the addition of the glycerol affected the viscosity of the resin, the viscosity was measured with a Brookfield viscometer, spindle number 3 at number 12 setting over time at t=24 hours, 1 week, 2 weeks, and 4 weeks.

Test cores were prepared by the no-bake process to determine whether the addition of the glycerol to the binder adversely affected the core properties. The test cores were prepared by preparing a foundry mix by (1) first mixing the NOVASET HP® resin with Wedron 540 sand, and (2) then mixing the co-reactant with the mixture of NOVASET HP® and sand, such that weight ratio of the resin to co-reactant is 4:1 and the amount of binder (NOVASET HP® resin and co-reactant) is two weight percent based upon the weight of the sand. The test cores were prepared by forcing the foundry mix into a standard core box (dog bone shape) and allowing the shape to cure. Then the tensile strengths (in psi) of the test cores were measured according to ASTM #329-87-S, known as “Briquette Method,” after allowing them to set at room temperature for 1 hour and 24 hours after removing them from the pattern. In order to check the resistance of the test core to degradation by humidity, the test core was held at room temperature for 24 hours and then stored in a humidity chamber for 1 hour at a relative humidity of 90 percent and a temperature of 25° C. before the tensile strength of the test core was measured.

The results of the stability tests and the strength tests are set forth in Tables 1-4.

TABLE 1
STABILITY TEST DATA ON BINDER AGED FOR 24 HOURS AND
PSI OF TEST CORES MADE WITH BINDER

| | Control A | Control B | Example 1 | Example 2 | Example 3 | Example 4 |
|---|---|---|---|---|---|---|
| Temperature | Ambient | 40° C. | Ambient | 40° C. | Ambient | 40° C. |
| Glycerol (%) | 0 | 0 | 1 | 1 | 10 | 10 |
| Viscosity (cP) | 53 | 51 | 40 | 40 | 81 | 93 |
| 1 hr (psi) | 54 | 55 | 45 | 46 | 32 | 32 |
| 24 hrs (psi) | 160 | 160 | 149 | 153 | 122 | 127 |
| 24 + 1 hrs (psi) | 129 | 108 | 125 | 113 | 106 | 111 |

TABLE 2
STABILITY TEST DATA ON BINDER AGED FOR ONE WEEK AND
PSI OF TEST CORES MADE WITH BINDER

| | Control A | Control B | Example 1 | Example 2 | Example 3 | Example 4 |
|---|---|---|---|---|---|---|
| Temperature | Ambient | 40° C. | Ambient | 40° C. | Ambient | 40° C. |
| Glycerol (%) | 0 | 0 | 1 | 1 | 10 | 10 |
| Viscosity (cP) | 58 | 90 | 43 | 61 | 85 | 131 |
| 1 hr (psi) | 47 | 71 | 40 | 54 | 32 | 45 |
| 24 hrs (psi) | 161 | 157 | 137 | 148 | 112 | 95 |
| 24 + 1 hrs (psi) | 120 | 107 | 112 | 111 | 107 | 87 |

TABLE 3
STABILITY TEST DATA ON BINDER AGED FOR TWO WEEKS AND
PSI OF TEST CORES MADE WITH BINDER

| | Control A | Control B | Example 1 | Example 2 | Example 3 | Example 4 |
|---|---|---|---|---|---|---|
| Temperature | Ambient | 40° C. | Ambient | 40° C. | Ambient | 40° C. |
| Glycerol (%) | 0 | 0 | 1 | 1 | 10 | 10 |
| Viscosity (cP) | 58 | 146 | 52 | 77 | 101 | 183 |
| 1 hr (psi) | 52 | 65 | 43 | 52 | 33 | 46 |
| 24 hrs (psi) | 147 | 156 | 131 | 136 | 130 | 132 |
| 24 + 1 hrs (psi) | 139 | 124 | 125 | 123 | 100 | 106 |

TABLE 4
STABILITY TEST DATA ON BINDER AGED FOR FOUR WEEKS AND
PSI OF TEST CORES MADE WITH BINDER

| | Control A | Control B | Example 1 | Example 2 | Example 3 | Example 4 |
|---|---|---|---|---|---|---|
| Temperature | Ambient | 40° C. | Ambient | 40° C. | Ambient | 40° C. |
| Glycerol (%) | 0 | 0 | 1 | 1 | 10 | 10 |
| Viscosity (cP) | 67 | Solid* | 53 | 251 | 120 | 810 |
| 1 hr (psi) | 43 | N/A | 42 | 44 | 47 | 33 |
| 24 hrs (psi) | 167 | N/A | 141 | 119 | 127 | 106 |
| 24 + 1 hrs (psi) | 136 | N/A | 122 | 99 | 98 | 68 |

*Note: Viscosity could not be measured because resin gelled

The data in Tables 1-4 clearly show that the aqueous basic solution of a phenolic resole resin containing glycerol is more storage stable, which is suggested by the fact that aqueous basic solutions of a phenolic resole resin containing the glycerol do not advance significantly over the four week period when the viscosity was measured. The data also show that the tensile strengths of the tests cores made with an aqueous basic solution of a phenolic resole resin containing glycerol is not adversely affected by the addition of the glycerol.

### Example 5

In this example, samples of alkaline phenolic resin solutions were added to clear containers and allowed to sit for 1 week. Skin/flake buildup had formed on the sides of the containers to varying degrees with less forming in the samples with increased amounts of glycerol. The samples were then agitated for one minute. After 30 minutes, the samples with glycerol had considerable less undissolved skin/flake buildup than the control sample.

The examples illustrate specific embodiments of the invention. They are not intended to exhaust all potential embodiments of the invention within the scope of the claims.

1. An alkaline phenolic resole resin composition comprising (a) an aqueous basic solution of a phenolic resole resin, and (b) an effective stabilizing amount of a polyhydric alcohol.

2. The alkaline phenolic resole resin composition of claim 1 wherein the polyhydric alcohol is selected from the group consisting of sugar alcohols like glycerol, erythritol, arabitol and alcohols like trimethylol ethane, trimethylol propane, pentaerythritol and polyvinyl alcohol, and mixtures thereof.

3. The alkaline phenolic resole resin composition of claim 2 wherein the amount of polyhydric alcohol used in the alkaline phenolic resole resin composition is from 0.5 to 15 weight percent based upon the weight to the alkaline phenolic resole resin.

4. The alkaline phenolic resole resin composition of claim 3 wherein the polyhydric alcohol is glycerol.

5. The alkaline phenolic resole resin composition of claim 4 wherein the amount of polyhydric alcohol used in the alkaline phenolic resole resin composition is from 0.9 to 5 weight percent.

6. The alkaline phenolic resole resin composition of claim 5 wherein the aqueous basic solution of the phenolic resole resin has (1) a viscosity of less than about 850 centipoises, (2) a solids content of 35 percent by weight to 75 percent by weigh based upon the total weight of the aqueous basic solution, and (3) an equivalent ratio of base to phenol of from 0.2:1.0 to 1.1:1.0, preferably from 0.3:1.0 to 0.95:1.0.

7. A foundry mix comprising a major amount of an aggregate and an alkaline phenolic resole resin composition of claim 1, 2, 3, 4, 5, or 6.

8. A no bake process for preparing a foundry shape comprising mixing the foundry mix of claim 7 with a liquid ester co-reactant, inserting the mixture into a pattern, allowing the mixture to cure, and removing the mixture from the pattern.

9. A cold box process for preparing a foundry shape comprising blowing the foundry mix of claim 7 into a pattern, contacting the foundry mix with the vapor of a volatile ester co-reactant or carbon dioxide.

10. A process for casting a metal part comprising fabricating a casting assembly comprising one or more foundry shapes prepared in accordance with claim 8, pouring molten into and around said casting assembly, allowing said low melting metal to cool and solidify, and then separating the molded article from the casting assembly.

11. A process for casting a metal part comprising fabricating a casting assembly comprising one or more foundry shapes prepared in accordance with claim 9, pouring molten into and around said casting assembly, allowing said low melting metal to cool and solidify, and then separating the molded article from the casting assembly.

12. A process for dissolving the crusted surface of an alkaline phenolic resole resin or the flakes formed when the crusted surface is subjected to mechanical forces comprising:
treating the alkaline phenolic resole resin with an effective stabilizing amount of polyhydric alcohol.

13. The process of claim 12 wherein the polyhydric alcohol is selected from the group consisting of sugar alcohols like glycerol, erythritol, arabitol and alcohols like trimethylol ethane, trimethylol propane, pentaerythritol and polyvinyl alcohol, and mixtures thereof.

14. The process of claim 13 wherein the amount of polyhydric alcohol used in the alkaline phenolic resole resin composition is from 0.5 to 15 weight percent based upon the weight to the alkaline phenolic resole resin.

15. The process of claim 14 wherein the polyhydric alcohol is glycerol.

16. The process of claim 15 wherein the amount of polyhydric alcohol used in the alkaline phenolic resole resin composition is from 0.9 to 5 weight percent.

17. The process of claim 16 wherein the aqueous basic solution of the phenolic resole resin has (1) a viscosity of less than about 850 centipoises, (2) a solids content of 35 percent by weight to 75 percent by weight based upon the total weight of the aqueous basic solution, and (3) an equivalent ratio of base to phenol of from 0.2:1.0 to 1.1:1.0, preferably from 0.3:1.0 to 0.95:1.0.
